(19) United States
(12) Patent Application Publication
(10) Pub. No.: US 2013/0216290 A1
(43) Pub. Date: Aug. 22, 2013

(54) Label Printing Device and Process for Using the Same

(71) Applicant: Ross A. Kimble, Crawfordsville, IN (US)

(72) Inventor: Ross A. Kimble, Crawfordsville, IN (US)

(21) Appl. No.: 13/772,329

(22) Filed: Feb. 21, 2013

Related U.S. Application Data
(60) Provisional application No. 61/601,023, filed on Feb. 21, 2012.

(51) Int. Cl. B41J 3/407

(52) U.S. Cl. CPC B41J 3/4075
USPC 400/76

(57) ABSTRACT

Disclosed is a label printing device and a method of using the device to label objects with time and date information. For example, the label printing device may be used to label food with time and date information. The label printing device is configured to provide a simple means of labeling. Illustrative configurations of the label printing device provide a primary print effectuator, e.g. a button, so that user input requirements are minimized.

### RELATED APPLICATIONS

This patent claims priority from U.S. Provisional Application Ser. No. 61/601,023 entitled “LABEL PRINTING DEVICE AND PROCESS FOR USING THE SAME” filed on Feb. 21, 2012, which is hereby incorporated by reference in its entirety.

### FIELD OF INVENTION

The present invention relates to a device for printing a label.

### BACKGROUND

Hand-held labeling devices are known for printing information on labels. Devices have included keyboards, optical readers, scanners, data connectors and a myriad of other means for inputting data. Data is typically entered into the devices through or by a user interacting with a user interface. This user interface may be a computer or hand-held computing device connected to the labeling device by a data connector (e.g. USB cable). Many devices require the device user to input data into the device using a series of key strokes or manipulations on a multiplicity of buttons. Some recent designs include full keyboards to facilitate typing on the hand-held labeler (e.g. U.S. Pub. No. 2004/0036915). The complexity of entering data into labeling devices creates a barrier to wide-spread use and adoption. Labeling devices that interface with computing devices are often fraught with complications and frustration. A labeling device that enables simple user interfacing overcomes these problems.

### SUMMARY

The present disclosure describes a label printing device. In illustrative embodiments, the device prints labels upon a user interacting with a print effectuator. A user interacting with the print effectuator causes the device to print and eject a label.

In illustrative embodiments, the label includes time and date information. In another embodiment, the device includes a time-date viewer and a time-date display, the time-date display displaying time and date information. In further illustrative embodiments, a user interacting with the print effectuator causes the time and date information to be printed onto adherent print media. In another embodiment, a user interacting with the print effectuator causes the adherent print media upon which time and date information has been printed to be ejected from the device.

The present disclosure describes a method of labeling food with time and date information that includes interacting with a print effectuator of a label printing device, receiving a printed label from the label printing device, and contacting the label with a food container so that the food therein is labeled with time and date information.

### BRIEF DESCRIPTION OF THE DRAWINGS

FIG. 1 is a drawing showing an exemplary label printing device.

FIG. 2 is a drawing showing the back of the exemplary label printing device shown in FIG. 1.

FIG. 3 is a drawing showing the back of the exemplary label printing device shown in FIG. 2 with the access door removed.

FIG. 4 is a drawing showing an alternative embodiment of the label printing device.

FIG. 5 is a drawing showing an alternative embodiment of the label printing device.

### DETAILED DESCRIPTION

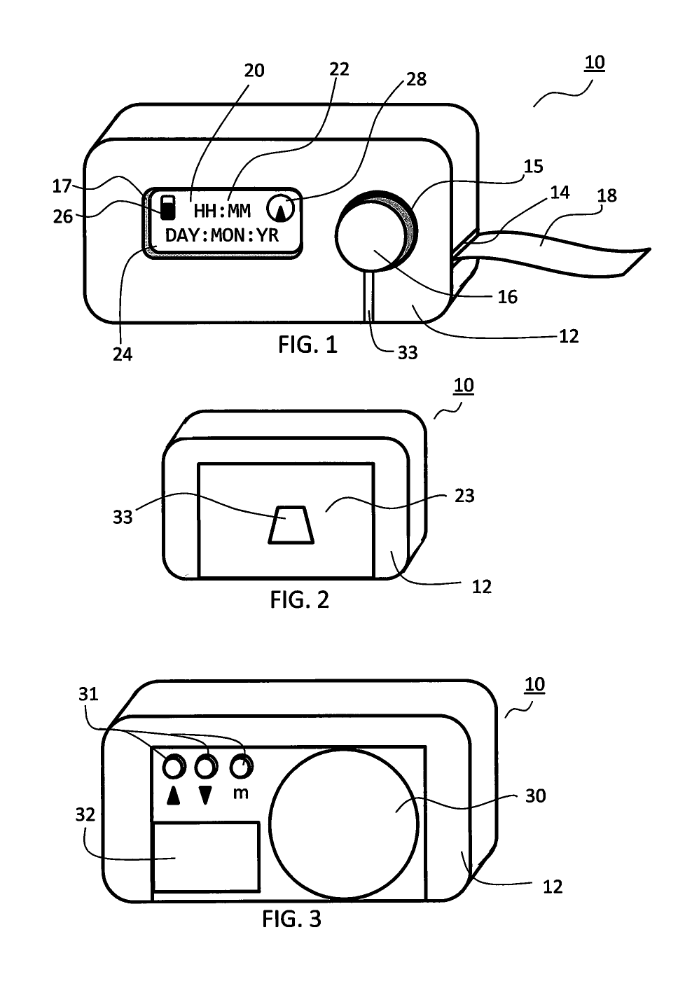

Referring now to FIG. 1, shown is an illustrative embodiment of a label printing device 10 including an exterior casing 12 comprising an ejection aperture 14, a print effectuator access 15, and a time-date viewer 17. The device further comprises a time-date display 20 configured to display time and date information 22, the time-date display positioned predominantly within exterior casing 12 in a position aligned to time-date viewer 17 such that time and date information 22 may be viewed from outside exterior casing 12. The device further includes an adherent print-receiving media 18 and a printing module, not shown. A print effectuator 16 is positioned adjacent to, internally to, or accessibly aligned with print effectuator access 15. In illustrative embodiments, print effectuator 16 is configured so that interacting with, depressing, or toggling print effectuator 16 causes the printing module to print the time and date information 22 onto the adherent print-receiving media 18. In another embodiment, printing module is configured so that interacting with, depressing, or toggling print effectuator 16 causes adherent print-receiving media 18 to dispense from exterior casing 12 through ejection aperture 14. In one embodiment, print effectuator 16 is a primary print effectuator. In another embodiment 16, print effectuator 16 is a dominant print effectuator. In yet another embodiment, print effectuator 16 is a sole print effectuator.

Referring to FIG. 2, device 10 includes an access door 23. Referring now to FIG. 3, access door 23 of FIG. 2 provides access to a battery slot 32 and an adherent print media holder 30 configured to receive the adherent print-receiving media. In another embodiment, access door 23 may further provide access to time and date set buttons 31.

Referring again to FIG. 1, exterior casing 12 is shown having a rectangular shape with rounded corners. In illustrative embodiments, the shape of the exterior casing is any shape suitable for the purposes described herein. In one embodiment, the exterior casing is small. As used herein, the term small means that the casing is less than about 6 inches by 6 inches by 3 inches. For example, exterior casings suitable for the purposes described herein may have an exterior volume (e.g. displacement) of less than about 100 cubic inches, less than about 75 cubic inches, less than about 50 cubic inches, less than about 34 cubic inches, less than about 12 cubic inches, less than about 6 cubic inches, less than about 4 cubic inches, between about 0.5 cubic inches and about 100 cubic inches, between about 2 cubic inches and about 50 cubic inches, between about 4 cubic inches and about 34 cubic inches, or between about 3 cubic inches and about 12 cubic inches. As shown in FIG. 1, the shape of exterior casing 12 is rectangular with rounded corners, the rectangle having dimensions of approximately 3 inches by approximately 2 inches with a depth of approximately 1 inch. As such, the exterior volume is approximately 6 cubic inches. The volume of the exterior casing should be sufficiently large to include a number of features that may be included therein. For example, in some embodiments the exterior casing may be configured to include an adherent print media holder, such as exemplary adherent print media holder 30, shown in FIG. 3. In other embodiments, the exterior casing may be configured to include a battery slot, such as exemplary battery slot 32, also shown in FIG. 3. For devices wherein the exterior casing is configured to enclose these features, in their entirety, the exterior casing must be of sufficient volume to receive batteries and/or adherent print media. Many standard batteries (e.g. AAA, AA, 9V) and adherent print medias (e.g. tape rolls, label sheets) are known to have various sizes; accordingly, a device configured sufficiently large to include standard batteries and adherent print medias is preferred.

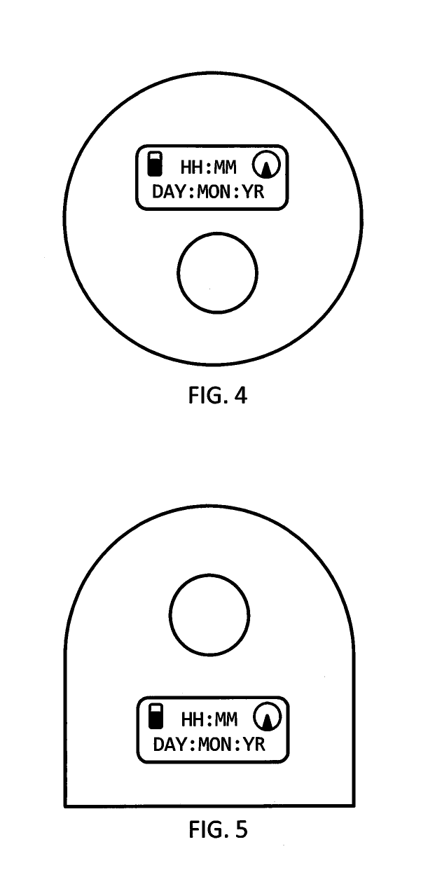

In illustrative embodiments, a device according to the present disclosure includes an exterior casing that is round in profile. Referring now to FIG. 4, shown is a device according to one embodiment of the present disclosure that includes a round exterior casing. Referring now to FIG. 5, shown is a device according to one embodiment of the present disclosure that includes a partially round exterior casing. According to one aspect, a round exterior casing or an exterior casing having circular features may maximize the internal volume of the casing where the adherent print media is configured as a roll. For example, the adherent print media holder may be configured to receive a circular roll and the holder may be oriented and aligned in a manner such that the roll is positioned to fill the circular portion of the round exterior casing. In another embodiment, the exterior casing may be elliptical. An elliptical exterior casing would likewise enhance interior volume while exhibiting a pleasing and/or ergonomically advantageous exterior design.

As described herein, many devices of the prior art enable data input from users using complex input mechanisms. These input mechanisms include full keyboards, computer connections be they wired or wireless, or complicated arrays of input buttons. One aspect of the present disclosure is that a device according to an illustrative embodiment of the present invention includes a very simple user input mechanism. For example, a device may include a primary print effectuator. As used herein, a primary print effectuator is a means for effectuating printing that requires only a single user input to effectuate printing. For example, a print effectuator may be a button, depressible or contact sensitive. The print effectuator may be a contact sensor based on conductivity or spring action. The print effectuator may be a switch or a toggle that has two or more positions. The print effectuator may be a dial or handle that effects printing upon a gradation of movement. In one embodiment, a primary print effectuator effectuates printing with a single input of a user such that the primary print effectuator has only a single function, that function being to effectuate printing. For example, if the print effectuator is a button, the button may be configured as a primary print effectuator so that a single depression of that button results in a single printing event. One aspect of the present disclosure is that a primary print effectuator substantially facilitates device simplicity so that user adoption is dramatically and surprisingly enhanced. While not being limited to any particular theory, it is understood that the simplicity of the user interaction with a given electronic device has an inverse relationship to the willingness of a user to interact with said device. As such, a device, such as one described herein having extraordinary simplicity, will garner an unprecedented willingness of a user to interact therewith.

In illustrative embodiments, the print effectuator is a dominant print effectuator. As used herein, a dominant print effectuator is means for effectuating printing which has a characteristic distinguishing means causing the print effectuator to be recognizable when compared to all other aspects of a device. Referring now to FIG. 1, print effectuator 16 may be described as a dominant print effectuator because it is strongly distinguished from all other aspects of the device. In particular, print effectuator 16 is the only button on the label printing device. As shown, print effectuator 16 is the only user input mechanism on the exterior of the exterior casing. As such, the print effectuator is distinguished by its singularity. Had the label printing device contained two buttons with identical physical attributes in similarly positioned locations, the print effectuator could not be described as dominant. A distinguishing means may include a physical attribute that distinguishes the print effectuator from other aspects of the device. For example, the distinguishing means could include use of a color, size, shape, or illumination that brings attention to the print effectuator. In illustrative embodiments, the print effectuator is dimensionally distinguished. For example, the print effectuator may be larger than other input mechanisms on the device (e.g. have a surface area of between about 0.5 square inches to about 4 square inches, about 0.7 square inches to about 3 square inches, or about 1 square inch to about 2 square inches). In another embodiment, the print effectuator may be a color that is distinct from the color of the exterior casing and/or other input mechanisms. For example, a bright color (e.g. red, orange, yellow, green, blue, purple, white) may be used to distinguish the print effectuator from the other aspects of the device, wherein the exterior casing has a color selected to be distinct from the bright color.

In illustrative embodiments, a labeling device includes a sole print effectuator. As used herein, a sole print effectuator is the only user input mechanism on the exterior of the label printing device. Referring to FIG. 1, the embodiment shown includes print effectuator 16 as the only input mechanism on the exterior of the label printing device. According to this embodiment, the user cannot enter data, modify the printer output, or in any way modify the status of the device except for printing of a label through interaction with the print effectuator. As described herein, the inability of the user to interact with the device in any other way except for through the print effectuator results in an extraordinarily simple device. This simplicity enables the device to be used by a myriad of users that would be incapable of properly operating devices of the prior art. For example, persons unable to read or write would be capable of producing label with accurate and expeditious ease by depressing a single button, or the like. Persons in extreme haste, otherwise incapable of performing an additional complex task, would be able to quickly generate a label. Even motivationally challenged individuals that are reluctant to exert themselves in any way may interact effortlessly with the push of a single button.

In illustrative embodiments, a device according to the present disclosure includes a self-setting mechanism. As used herein, a self-setting mechanism generates time and date information without user interaction. For example, atomic clocks are known which are capable of receiving signals that contain time and date information. In another example, the device includes pre-programmed time and date information and is capable of maintaining that pre-programmed information despite disruptions in power and display of that power. For example, the device may include a reserve battery or capacitor that allows the device to be unpowered for extended periods of time without disruption to the pre-programmed time.

In illustrative embodiments, a device according to the present disclosure includes a time-date display 20 and time-date viewer 17. In one embodiment, a time-date viewer is simply an aperture in the exterior case which allows the time-date display, predominantly located inside the exterior case, to be viewed. In another embodiment, the time-date viewer includes a secondary material, diverse to the primary material in which the exterior case, that enables the time-date display to be seen. An exemplary material for an illustrative time-date viewer includes a clear or translucent polymer or glass which is mechanically attached and sealed or adhered and sealed to the exterior casing such that an effectively water-tight (e.g. water resistant, water proof) seal exists between the time-date viewer and the exterior casing. The effectively water tight seal permits the exterior casing of the device to be cleaned, such as by wiping with a damp cloth, without damaging internal components, such as the printing module and the time-date display. In illustrative embodiments, the time date display has sufficient dimensions so that viewing relatively large font sizes is possible (e.g. greater than about 6 pt, greater than about 10 pt, greater than about 14 pt, greater than about 18 pt, greater than about 28 pt, greater than about 36 pt, up to about 72 pt, between about 6 pt and about 72 pt, between about 10 pt and about 28 pt, or between about 12 pt and about 36 pt, wherein 1 pt is equal to 1/72 of an inch). In illustrative embodiments, in order to display time and date information with a typeface font of between 12 and 36 points, the time-date display may have a surface area from about 3 square inches to about 8 square inches. The ability to clearly display large font sizes reduces eye-strain, contributes the simplicity of the device, maximizes accessible use by individuals with limited vision impairments, and most importantly, provides for a more enjoyable and therefore more valuable user experience when compared to prior art. Because of the large variability of user demographics, the relatively large and simplified format of the time and date information provides surprising utility to the device. Because a device according to the present disclosure may include very few user inputs (e.g. less than about 20, less than about 15, less than about 10, less than about 5, less than about 3, or about 1), much of the exterior area of the device can be dedicated to a large and easy to read time-date viewer and/or time-date display. The combination of few user inputs and large time-date display was found to be particularly useful in a device according to the present disclosure.

In further illustrative embodiments, the time date display includes additional informational icons. Referring now to FIG. 1, shown on time date display 20 are optional informational icons for battery status 26 and remaining print media 28. These optional features further enhance the ease of use of the device without adding to the complexity.

In illustrative embodiments, a device according to the present disclosure includes a time-date display 22. As used herein, the time date display is the means by which the device provides both the user and the printing module the information which will be printed upon actuation of the print effectuator. The time date display is capable of providing relatively large font sizes, for example, as large as 36 point font, which facilitates use by a large and highly variable user demographic group. The time date display may be displayed in digital form or analog form, (e.g. the analog form being digitally derived). There are numerous common and previously published means of provision of dynamic digital time and date information. These include, but due to the vast nature of the published prior art, are not limited to various forms of light emitting diodes (LED), electroluminescent displays (ELD), plasma display panels (PDP), liquid crystal displays (LCD), thin film transistors (TFT), and organic light-emitting diodes (OLED). These may be utilized either in the form of full area two dimensional displays or as segmented displays in the present disclosure.

In illustrative embodiments, a device according to the present disclosure includes an adherent print-receiving media. As used herein, the adherent print-receiving media may be printed upon by the module printing the time and date information. The printing media may be in the form of individual labels having an adhesive backing which are uniformly positioned on a continuous roll or individual sheets of paper having a composition which allows the labels to be easily removed, such as used for addressing envelopes. These types of labels are common and have various adhesive compounds. As used herein, the adherent print-receiving media may be a continuous roll of adhesive backed material which is perforated for easy removal of individual labels. As used herein, the adherent print-receiving media may be an adhesive backed tape of composition such that the tape is capable of directly receiving the printed date information. The print-receiving media may be cellulosic, paper-based, polymer-based, synthetic, natural, or any combination thereof. Common label materials which may be configured to be compatible with the device are coated paper, laminated paper, polypropylene, and synthetic composites such as combinations of polyolefin (e.g. HDPE, LDPE, HDPP, LDPP) and silica. In one embodiment, a device according to the present disclosure is configured to use print-receiving media which are soluble in warm water. Combined with and configured with a device of the present disclosure, the benefit of a warm-water soluble composition is that no extra effort will be required to remove the label from food containers intended for washing and reuse, thus extending the user friendly nature and operational simplicity of the present device and method. Label materials having these characteristics are known for separate, non-autonomous uses, see U.S. Pat. No. 4,444,839. Of environmental benefit are those print-receiving media which are biodegradable. Biodegradable printing media provides the additional benefit of ease of conscience for some device users. Furthermore, heat sensitive label media, e.g. for thermal transfer printing mechanisms, may be utilized.

In illustrative embodiments, a device according to the present disclosure includes a printing module. In illustrative embodiments, the printing module is the internal mechanism which prints the time and date information on the adherent print-receiving media and which advances that media such that the operator may easily access the label. There are numerous manufacturers of printing modules using a variety of technologies having a long history of use. In one embodiment, the printing module may be of thermal resistance or transfer technology, for example, see U.S. Pat. No. 4,446,467 and U.S. Pat. No. 5,547,293. Direct thermal technology is of specific interest in the present device because of its relative low cost, and the absence of consumable ink or materials. Direct thermal printing technology, comprising heating or burning an image into a media, would contribute to the simplistic nature of the present device by its inherent low maintenance. In another embodiment, the printing module may be of thermal transfer technology, in which a heated print head causes ink from a ribbon to be printed on a label. This form of printer may facilitate printing to a wider range of print media types. In another embodiment, the printing module may be of ink jet or laser technology, particularly as advancements in these types of devices allow them to become smaller.

In illustrative embodiments, a device according to the present disclosure includes a print media viewing window 33, as shown in FIG. 1. In one embodiment, the print media viewing window is a separate or extended portion of the time date viewer which allows for visual observation of the amount of unused label media. This simplistic means of viewing the remaining supply of labels contributes to the easy operation of the device. The window may be comprised of a clear polymer or glass, sealed to the device enclosure similar to that of the time date viewer.

In illustrative embodiments, a device according to the present disclosure includes a positioning mechanism 34, as shown in FIG. 2. In one embodiment, the positioning mechanism allows for easy attachment of a magnet, hook and loop connecting means, or a mechanical clip assembly suitable for use with double sided tape. These means of positioning mechanisms, attached to the rear of the device, on or adjacent to the access door, allow the device to be prominently and conveniently located. This attribute will reduce the chance that the device may be lost or damaged and will increase the likelihood of its use. An example of this would be a magnet which allows the device to be located on certain types of refrigerators.

In illustrative embodiments, a label printing device comprises an exterior casing comprising an ejection aperture, a print effectuator access, a time-date viewer, a time-date display configured to display time and date information, the time-date display positioned predominantly within the exterior casing in a position aligned to the time-date viewer such that the time and date information may be viewed from outside the exterior casing, an adherent print-receiving media, a printing module, and a print effectuator positioned adjacent to, internally to, or accessibly aligned with the print effectuator access. In one embodiment, the print effectuator is configured so that interacting with, depressing, or toggling the print effectuator causes the printing module to print the time and date information onto the adherent print-receiving media. In another embodiment, the printing module is configured so that interacting with, depressing, or toggling the print effectuator causes the adherent print-receiving media to dispense from the tape aperture through the ejection aperture. In yet another embodiment, the exterior casing includes a singular print effectuator access and a singular print effectuator. In one embodiment, the exterior casing further comprises an internal access door providing access to a battery slot and a roll entrapment region configured to receive the adherent print-receiving media. In another embodiment, the internal access door further provides access to time and date set buttons. In yet another embodiment, the adherent print-receiving media is configured to be water soluble. In another embodiment, the adherent print-receiving media comprises a polymeric sheet and an adhesive composition, the adhesive composition is configured to dissolve in aqueous solutions. In another embodiment, the polymeric sheet is soluble in hot water. In yet another embodiment, the polymeric sheet is soluble in hot water and biodegradeable. In another embodiment, the exterior casing includes only one print effectuator access, only one time-date viewer, and only one time-date display. In one embodiment, the device includes only one print effectuator. In another embodiment, the only one print effectuator is a button.

In illustrative embodiments, a label printing device consists of an exterior casing, a time-date display configured to display time and date information, the time-date display positioned predominantly within the exterior casing, an adherent print-receiving media, a printing module, and a print effectuator. In one embodiment, the print effectuator is configured as a button and the printing device is devoid of any other external user inputs except for the button.

In illustrative embodiments, a method of labeling food with time and date information comprises interacting with a print effectuator of a label printing device, receiving a printed label from the label printing device, and contacting the label with a food container so that the food therein is labeled with time and date information, wherein interacting includes a singular contacting of the print effectuator. In one embodiment, interacting with the print effectuator includes depressing, toggling, or otherwise contacting the print effectuator so that a printing module within the label printing device prints the time and date information on an adherent print media. In another embodiment, interacting with the print effectuator consists of depressing, toggling, or otherwise contacting the print effectuator so that a printing module within the label printing device prints the time and date information on an adherent print media. In yet another embodiment, the method requires only a single user input for the label printing device to generate a printed label. In one embodiment, the method is devoid of user inputs to the label printing device except for interacting with the print effectuator.

In illustrative embodiments, the present disclosure describes a method of labeling food with time and date information that includes interacting with a print effectuator of a label printing device, receiving a printed label from the label printing device, and contacting the label with a food container so that the food therein is labeled with time and date information. In one embodiment, interacting with the print effectuator includes depressing, toggling, or otherwise contacting the print effectuator so that a printer within the label printing device prints the time and date information on an adherent print media.

1. A label printing device comprising:
an exterior casing comprising an ejection aperture, a print effectuator access, a time-date viewer,
a time-date display configured to display time and date information, the time-date display positioned predominantly within the exterior casing in a position aligned to the time-date viewer such that the time and date information may be viewed from outside the exterior casing,
an adherent print-receiving media,
a printing module, and
a print effectuator positioned adjacent to, internally to, or accessibly aligned with the print effectuator access.

2. The device of claim 1, wherein the print effectuator is a primary print effectuator.

3. The device of claim 2, wherein the print effectuator is a dominant print effectuator.

4. The device of claim 1, wherein the print effectuator is a sole print effectuator.

5. The device of claim 1, wherein the exterior casing further comprises an internal access door providing access to a battery slot and a roll entrapment region configured to receive the adherent print-receiving media.

6. The device of claim 3, wherein the internal access door further provides access to time and date set buttons.

7. The device of claim 1, wherein the adherent print-receiving media is configured to be water soluble.

8. The device of claim 1, wherein the adherent print-receiving media comprises a polymeric sheet and an adhesive composition, the adhesive composition is configured to dissolve in aqueous solutions.

9. The device of claim 8, wherein the polymeric sheet is soluble in hot water.

10. The device of claim 8, wherein the polymeric sheet is soluble in hot water and biodegradeable.

11. The device of claim 1, wherein the exterior casing includes only one print effectuator access, only one time-date viewer, and only one time-date display.

12. The device of claim 1, wherein the device includes only one print effectuator.

13. The device of claim 12, wherein the only one print effectuator is a button.

14. A label printing device consisting of:
an exterior casing,
a time-date display configured to display time and date information, the time-date display positioned predominantly within the exterior casing,
an adherent print-receiving media,
a printing module, and
a print effectuator.

15. The label printing device of claim 14, wherein the print effectuator is configured as a button and the printing device is devoid of any other external user inputs except for the button.

16. A method of labeling food with time and date information comprising:
interacting with a print effectuator of a label printing device,
receiving a printed label from the label printing device, and
contacting the label with a food container so that the food therein is labeled with time and date information, wherein
interacting includes a singular contacting of the print effectuator.

17. The method of claim 16, wherein interacting with the print effectuator includes depressing, toggling, or otherwise contacting the print effectuator so that a printing module within the label printing device prints the time and date information on an adherent print media.

18. The method of claim 16, wherein interacting with the print effectuator consists of depressing, toggling, or otherwise contacting the print effectuator so that a printing module within the label printing device prints the time and date information on an adherent print media.

19. The method of claim 16, wherein the method requires only a single user input for the label printing device to generate a printed label.

20. The method of claim 16, wherein the method is devoid of user inputs to the label printing device except for interacting with the print effectuator.
